(19) United States
(12) Patent Application Publication
(10) Pub. No.: US 2016/0363244 A1
(43) Pub. Date: Dec. 15, 2016

(54) PIPE CLAMP WITH WORM DRIVE MECHANISM

(71) Applicant: Norma U.S. Holding LLC, Auburn Hills, MI (US)

(72) Inventors: Brian T. Ignaczak, Rochester, MI (US); Julia A. Vang, Sterling Heights, MI (US)

(21) Appl. No.: 15/180,818

(22) Filed: Jun. 13, 2016

Related U.S. Application Data
(60) Provisional application No. 62/174,879, filed on Jun. 12, 2015.

(51) Int. Cl. F16L 21/06

(52) U.S. Cl. CPC F16L 21/065

(57) ABSTRACT

A pipe clamp with a band and a worm drive mechanism that provides a fluid-tight seal at a joint involving one or more metal pipes. The worm drive mechanism includes a screw and a housing. The housing has an end wall located opposite a head of the screw. The end wall at least partially encloses a terminal end portion of the screw. Surface-to-surface abutment between the terminal end portion and the end wall during tightening precludes deformation of the housing that might otherwise be experienced.

### CROSS-REFERENCE TO RELATED APPLICATION

This application claims the benefit of U.S. Provisional Patent Application No. 62/174,879, filed Jun. 12, 2015, the entire contents of which are hereby incorporated by reference.

### TECHNICAL FIELD

This disclosure relates generally to pipe clamps used to connect metal exhaust pipes to each other, and, more particularly, to pipe clamps with worm drive mechanisms.

### BACKGROUND

Pipe clamps are typically used to exert a radially contracting force against underlying metal pipes to provide a joint between the pipes. Pipe clamps typically include a metal band and some sort of fastening mechanism to tighten the band over the pipes. To be effective, pipe clamps should provide a fluid-tight seal at the joint.

### SUMMARY

In an embodiment, a pipe clamp for a pipe lap joint may involve one or more metal pipes. The pipe clamp may include a band and a worm drive mechanism. The band extends from a first circumferential end to a second circumferential end. The band may have multiple slots that are spaced apart from one another along a section or more of the band. The worm drive mechanism may be connected to the band and may be operable to radially contract the band during tightening of the pipe clamp. The worm drive mechanism may include a screw and a housing. The screw has a shank with threads that engage the slots of the band when the screw is rotated. The shank has a terminal end portion. The housing has a cover that encloses a part or more of the shank. The cover includes an end wall located near the terminal end portion. The band is received in the housing underneath the screw, with one or more of the threads engaged with one or more of the slots. During tightening of the pipe clamp, the terminal end portion of the shank may bear against—directly or indirectly via an intermediate structure—the end wall. Thrust loads exerted by the screw during tightening are therefore braced in part or more by the end wall.

In another embodiment, a pipe clamp for a pipe lap joint may involve one or more metal pipes. The pipe clamp may include a band and a worm drive mechanism. The worm drive mechanism may include a screw and a housing. The screw may have a head and a terminal end portion. The housing may have a first end wall and a second end wall. During tightening of the pipe clamp, the head of the screw may bear against—directly or indirectly via an intermediate structure—the first end wall. And during tightening of the pipe clamp, the terminal end portion of the screw may bear against—directly or indirectly via an intermediate structure—the second end wall. Thrust loads exerted by the screw during tightening are therefore braced in part or more by the first end wall, and are braced in part or more by the second end wall.

It is envisaged that the various aspects, embodiments, examples, features, and alternatives set forth in the preceding paragraphs, in the claims, in the detailed description, and/or in the figures, may be taken independently and individually or in any combination thereof.

### BRIEF DESCRIPTION OF THE DRAWINGS

Embodiments of the disclosure will hereinafter be described in conjunction with the appended drawings, wherein like designations denote like elements, and wherein:

FIG. 1 is a perspective view of an embodiment of a pipe clamp;

FIG. 2 is another perspective view of the pipe clamp of FIG. 1;

FIG. 3 is yet another perspective view of the pipe clamp of FIG. 1;

FIG. 4 is a side view of the pipe clamp of FIG. 1;

FIG. 5 is an end view of the pipe clamp of FIG. 1;

FIG. 6 is a top view of the pipe clamp of FIG. 1;

FIG. 7 is a side view of a screw used with the pipe clamp of FIG. 1; and

FIG. 8 is an enlarged view of another embodiment of a pipe clamp.

### DETAILED DESCRIPTION

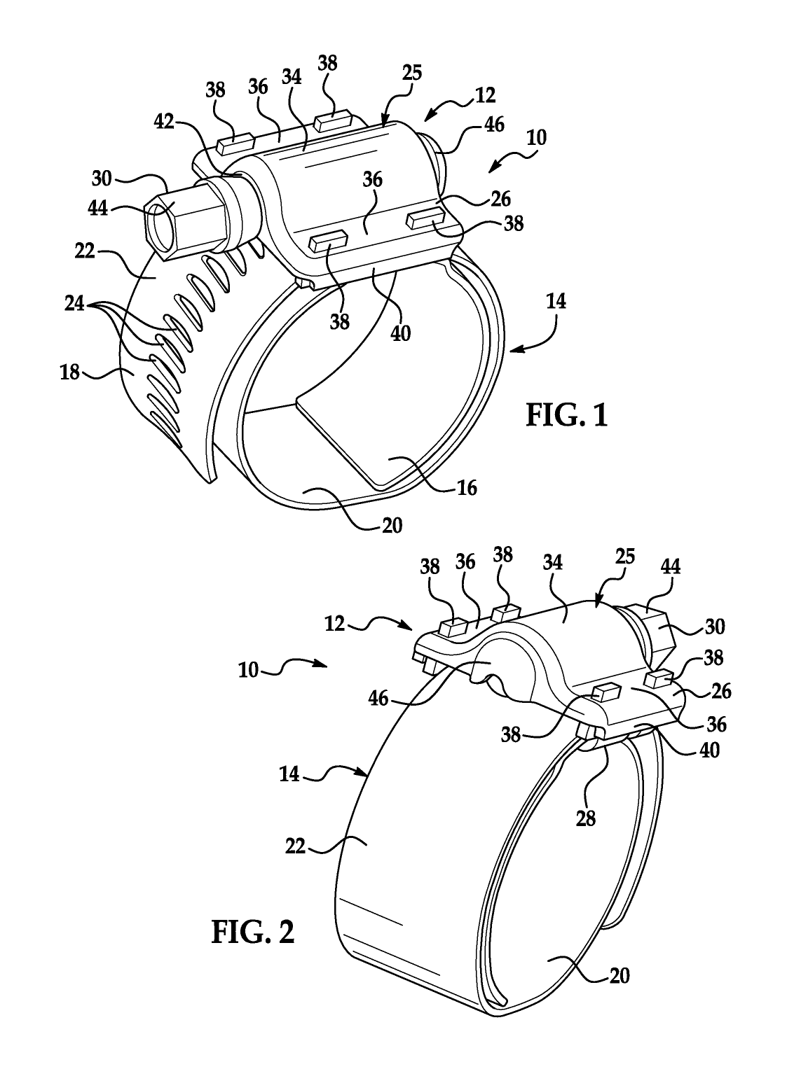

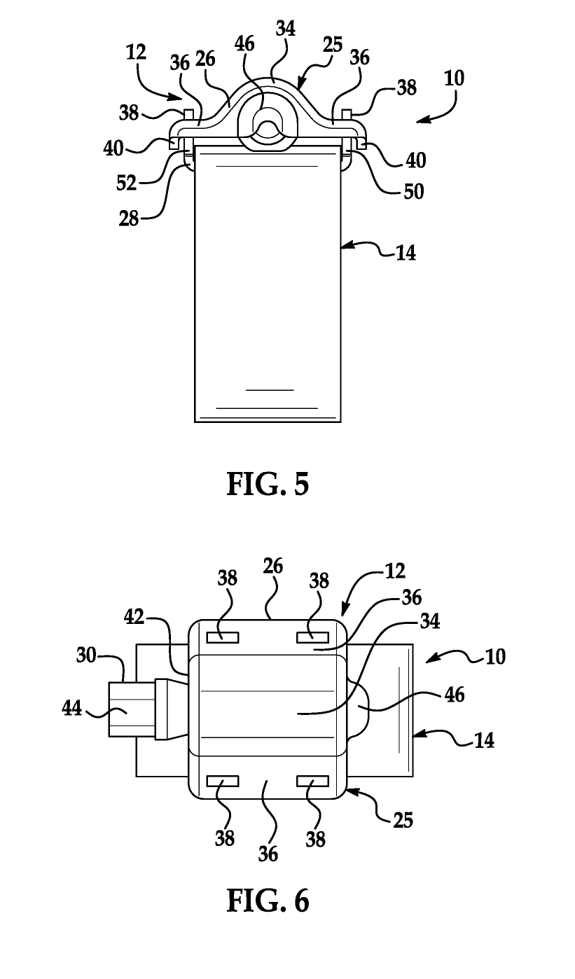

Referring to the drawings, FIGS. 1-8 depict embodiments of a pipe clamp with a worm drive mechanism that provides a fluid-tight seal at a pipe lap joint between a pair of overlapping metal pipes, or at a joint between a metal pipe and another component. While worm drive mechanisms have been used with hose clamps for rubber hose joints, the pipe clamp and worm drive mechanism herein have been designed and constructed for use with metal pipe(s). Metal pipe applications typically require a radially contracting force of greater magnitude than rubber hose applications in order to be effective and provide a fluid-tight seal against leakage. The pipe clamp and worm drive mechanism herein are hence designed and constructed with measures to withstand increased thrust loads associated with the greater magnitude, and to more readily impart the required radially contracting force. The pipe clamp is suitable for use with automotive exhaust pipes, aircraft pipes, marine pipes, industrial equipment pipes, as well as pipes in other industries. Furthermore, unless otherwise specified, the terms radially, axially, circumferentially, and their grammatical variations refer to directions with respect to the generally circular and somewhat cylindrical shape of the pipe clamp.

Referring to FIGS. 1-7, an embodiment of a pipe clamp 10 includes a band 14 and a worm drive mechanism 12. The band 14 can have different designs and constructions in different embodiments. In the embodiment presented in FIGS. 1-6, the band 14 is placed around the associated metal pipe(s) and is tightened down on the pipe(s) by the worm drive mechanism 12. The band 14 can be made of a metal material such as tempered stainless steel or another suitable metal, and can be formed to its final shape via suitable metalworking processes. The band 14 can be wider than bands used in rubber hose applications since the band 14 is intended for use with metal pipe applications; in specific examples, the band 14 can have an axial width that ranges between approximately 22 millimeters (mm) and approximately 38 mm; still, other width values are possible. The band 14 extends in the circumferential direction between a first circumferential end 16 and a second circumferential end 18. A connection to the worm drive mechanism 12 can be located at or adjacent the first circumferential end 16, at or adjacent the second circumferential end 18, or at a position somewhere between the first and second circumferential ends as illustrated in FIGS. 1-6. The second circumferential end 18 is free to move back-and-forth and in-and-out of the worm drive mechanism 12 during tightening and loosening of the pipe clamp 10. On a radially-inboard side, the band 14 has an inner surface 20 that, in use, directly or indirectly confronts the metal pipe(s); and on a radially-outboard side, the band has an outer surface 22.

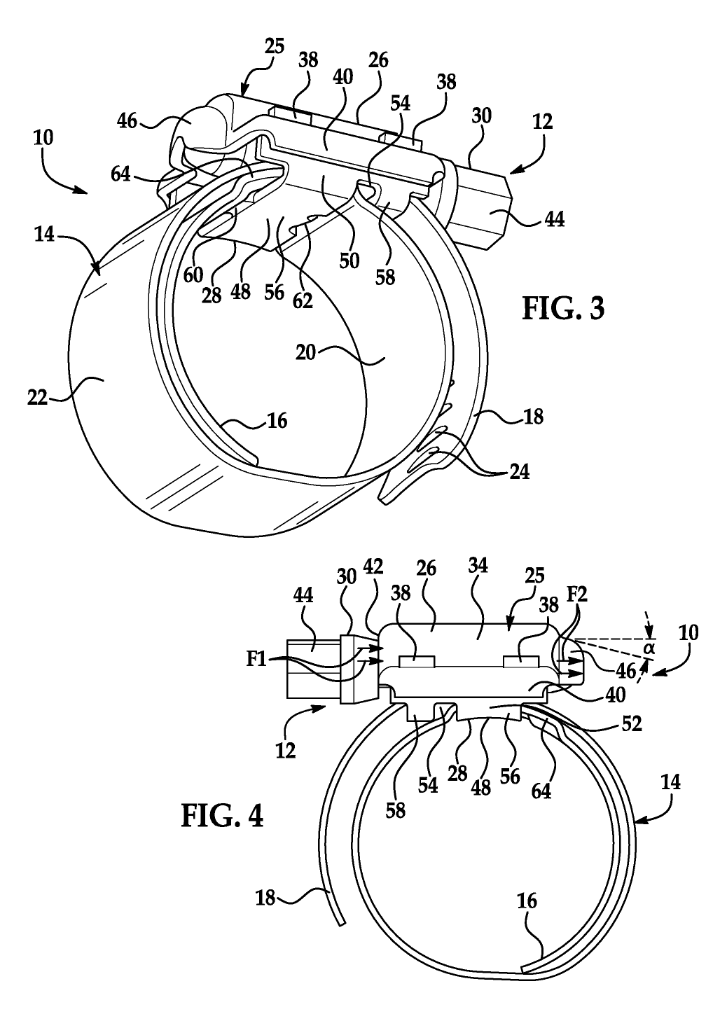

Furthermore, referring now particularly to FIGS. 1 and 3, the band 14 includes a set of slots 24 that are located in the body of the band, and, in this embodiment, are located near the second circumferential end 18. The slots 24 are engaged by the worm drive mechanism 12 during the tightening and loosening actions of the pipe clamp 10. The slots 24 are spaced apart from one another and extend along the circumference of the band 14 for an extent determined by the expected radial contraction amount of the particular application. In this embodiment, each of the slots 24 extends completely through the body of the band 14 between the inner and outer surfaces 20, 22. In other embodiments, the slots need not extend completely through the body and instead could be pinched or stepped structures formed in the band, embossments or upsets or insets formed in the band, or could have another formation; in this regard, the term “slots” is used broadly herein to embrace all of these possibilities. As depicted in the example of the figures, each slot 24 can have an arcuate edge directed toward one of the first or second circumferential ends 16, 18, and can have a planar edge located opposite the arcuate edge; other edge lines and slot shapes are possible.

The worm drive mechanism 12 is actuated to cause radial contraction and expansion of the band 14, and keeps the band at the intended radial position after actuation. When contracted, the band 14 imparts a radially contracting force over the underlying joint. In general, the worm drive mechanism 12 is located on the outboard exterior side of the band 14. The worm drive mechanism 12 can have different designs and constructions in different embodiments. In the embodiment presented in FIGS. 1-7, the worm drive mechanism 12 includes a housing 25 and a screw 30. The housing 25 is attached to the band 14 at a location between the band's circumferential ends 16, 18. In other embodiments, the housing 25 can be attached closer to the first circumferential end 16 than depicted in the figures. In the embodiment of the figures, the housing 25 includes a cover 26 and a saddle 28; yet in other embodiments the housing could include only a single component or could include additional and/or different components than shown and described here.

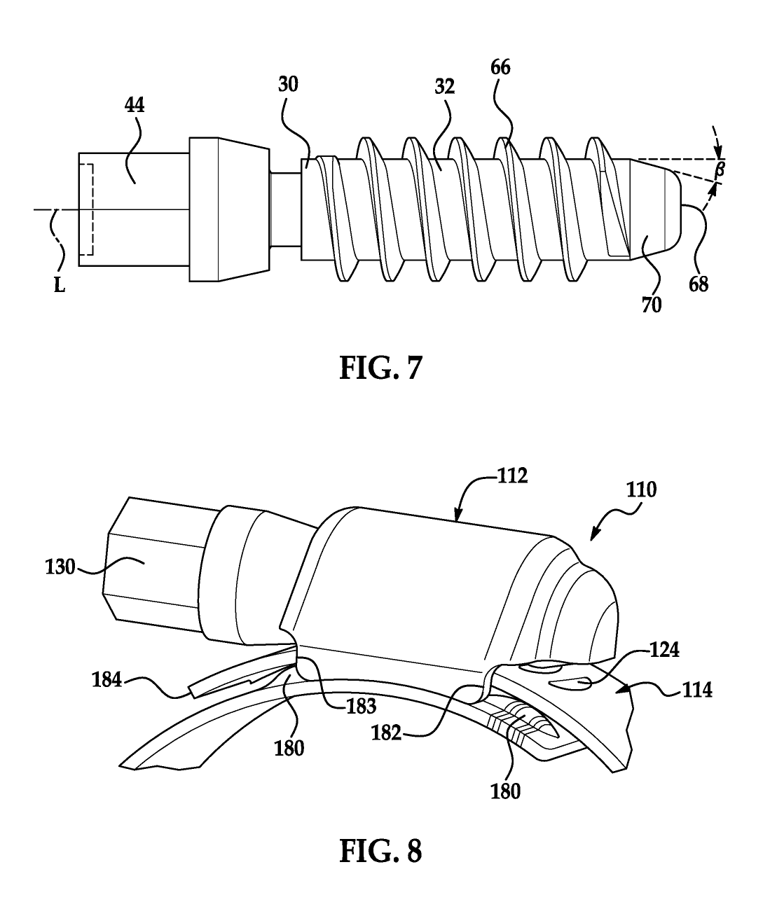

The cover 26 encloses a threaded shank 32 of the screw 30 (the threaded shank is shown best in FIG. 7). The cover 26 has a top wall 34 generally shaped as a half-cylinder and has a pair of lateral walls 36 extending from the top wall. The lateral walls 36 have openings for receiving tabs 38 that extend from the saddle 28, and together the interconnected openings and tabs provide a connection between the cover 26 and the saddle; still, other ways of providing a connection between the cover and saddle are possible including, for example, providing openings in the saddle and corresponding tabs in the cover. The cover 26 also has a skirt 40 that extends radially downwardly from each of the lateral walls 36. The cover 26 has a first end wall 42 adjacent a head 44 of the screw 30. The first end wall 42 has an opening for accommodating the shank 32 of the screw, and although the opening is not readily shown in the figures, it can present a half-circular cutout to match the cylindrical shape of the shank received therein. Opposite the first end wall 42, the cover 26 has a second end wall 46. The second end wall 46 presents a mostly closed end of the cover 26 that encloses at least part of the end of the shank 32 thereat. The second end wall 46 can have a somewhat rounded shape, as depicted in FIGS. 1-6, though need not. An inside surface of the second end wall 46 can directly confront the end of the shank 32.

The saddle 28 supports and guides movement of the band 14 in-and-out of the worm drive mechanism 12 during the tightening and loosening actions. The saddle 28 also provides part of the connection between the worm drive mechanism 12 and the band 14. Referring in particular to FIGS. 3-5, the saddle 28 has a bottom wall 48, a first sidewall 50 extending from the bottom wall, and a second sidewall 52 extending from the bottom wall. The bottom wall 48 has a cutout 54 for receipt of the band 14. The cutout 54 partitions the bottom wall 48 into first and second portions 56, 58. In assembly, the first portion 56 wraps around the band 14 and has first and second appendages 60, 62 for connection to the band. The appendages 60, 62 are inserted into a complementary opening in the band 14 at a raised section 64 of the band. The insertion provides a mechanical interconnection between the saddle 28 and the band 14. Still, other techniques for making a connection between the worm drive mechanism 12 and band 14 are possible. The raised section 64 is formed into the band 14 for more readily accommodating its receipt and for minimizing structural interruptions in the circumferential extent of the band when it is tightened down on the underlying metal pipe(s)—this is perhaps illustrated best in FIG. 4. The minimized interruption more evenly distributes radially contracting forces and reduces the likelihood of leak development. The raised section 64 presents a bulged radially-outboard portion of the band 14 in comparison to its other unraised portions. The second portion 58 wraps around the band 14 at a section of the band adjacent the slots 24. The first and second sidewalls 50, 52 extend radially-outboard from the bottom wall 48, and the tabs 38 extend even farther radially-outboard from the sidewalls.

The screw 30 is held between the cover 26 and the saddle 28, and is rotated to engage the slots 24 of the band 14 during the tightening and loosening actions. Referring particularly to FIG. 4, the screw 30 is arranged generally tangentially to the circumference of the band 14. Referring now to FIG. 7 which depicts the screw 30 isolated from other components, the screw 30 has the head 44 and the shank 32. The head 44 is located outside of the cover 26 in assembly for accessibility, while the shank 32 is enclosed inside of the cover in assembly. The shank 32 has threads 66 that are inserted into the slots 24 and, upon rotation of the screw 30, move the band 14 in-and-out of the cover 26 and saddle 28. Opposite the head 44, the screw 30 has a terminal end 68. The terminal end 68 in this example presents a generally planar surface at that end of the screw 30. The terminal end 68 directly confronts the inside surface of the second end wall 46.

Worm drive mechanisms are typically found on hose clamps for rubber hose joints. These worm drive mechanisms have not conventionally been used with joints involving one or more metal pipe(s) since the worm drive mechanisms could not furnish the needed radially contracting force for an effective fluid-tight seal without deforming in some way. Because the pipe clamp 10 herein is employed with a joint involving one or more metal pipe(s), the radially contracting force applied by the band 14 to the metal pipe(s), as mentioned, is typically much greater than those applied in rubber hose applications. The metal pipe(s) call for more force in order to properly provide a fluid-tight seal. The thrust loads experienced by the worm drive mechanism 12 are, in turn, much greater in metal pipe applications. The thrust loads are reaction forces in response to the tightening action and contraction of the band 14 as the screw 30 is rotated. Without the second end wall 46, the thrust loads would primarily be experienced by the first end wall 42 as the head 44 of the screw 30 directly bears against, and is urged against, the first end wall. In these cases, it has been found, the cover 26 would sometimes give-in to the thrust loads and consequently deform.

With the embodiment of the pipe clamp 10 presented in the figures, in contrast, the second end wall 46 endures at least part of the thrust loads and precludes deformation of the cover 26. Referring particularly to FIG. 4, the thrust loads are apportioned into first loads F₁ and second loads F₂. The first loads F₁ are endured by the first end wall 42 and are less than the thrust loads previously and primarily experienced by the first end wall. The second loads F₂ are endured by the second end wall 46. The terminal end 68 of the screw 30 directly bears against, and is urged against, the inside surface of the second end wall 46 when the screw is rotated to cause tightening action. The terminal end 68 and second end wall 46 make surface-to-surface abutment with each other. With the thrust loads shared this way, the cover 26 does not yield to them and is not deformed during tightening.

Furthermore, as described, the radially contracting force called for in metal pipe applications to effect a fluid-tight seal is typically greater than those called for in rubber hose applications. Thread-and-slot engagement effects the ultimately applied radially contracting force. In general, a thread-and-slot engagement that exhibits a greater insertion depth of thread-in-slot insertion, and exhibits a greater number of threads concurrently inserted in slots, can more readily apply an increased radially contracting force. The pipe clamp 10 and worm drive mechanism 12 herein are designed and constructed to impart the greater radially contracting force called for in metal pipe applications.

Referring to FIG. 4, the inside surface of the second end wall 46 makes an angle alpha (α) with the horizontal (horizontal defined by the left-to-right and right-to-left extent of the top wall 34 as shown in FIG. 4, and by a lengthwise extent of the cover 26 as shown left-to-right and right-to-left in FIG. 4); the inside surface, although not depicted in FIG. 4, has a surface contour like the outside surface depicted in the figure, and thus the angle α of the outside surface represents the angle α of the inside surface. Similarly, and referring now to FIG. 7, a tapered outside surface 70 of a terminal end portion of the screw 30 makes an angle beta (β) with the horizontal (horizontal being parallel to a longitudinal axis L of the screw 30; the numeral 70 also generally denotes the terminal end portion of the screw). In some embodiments, keeping the angles α and β within 5 degrees (°) of each other (i.e., value of α is plus 5° or minus 5° from value of β, or vice versa) improves thread-and-slot engagement and results in the application of an increased radially contracting force. In one embodiment, the angles α and β are substantially equal to each other (the term “substantially,” as used herein, is intended to account for the inherent degree of imperfection and imprecision accompanying manufacturing and metalworking processes commonly employed in pipe clamp applications). For example, when the screw 30 is rotated, the surface-to-surface abutment and corresponding angles α and β may work to urge the screw 30 toward the immediately underlying band 14 and hence bring about a greater insertion depth of thread-in-slot insertion thereat. The surface-to-surface abutment and corresponding angles α and β may also increase the number of threads concurrently inserted in slots while the screw 30 is rotated; for instance, instead of a total of three threads respectively engaged with three slots at the same time during screw rotation, a total of four threads may be respectively engaged with four slots at the same time.

FIG. 8 depicts another embodiment of a pipe clamp 110. The pipe clamp 110 is similar in some ways to the pipe clamp 10 of FIGS. 1-7, and those similarities will not necessarily be repeated here. In the embodiment of FIG. 8, one or more protrusion(s) 180 are located on a band 114 and near an entrance 182 of a worm drive mechanism 112. As shown, the protrusion(s) 180 may also be located near an exit 183 of the worm drive mechanism 112. The protrusion(s) 180 jut radially-outboard away from its immediately surrounding surface of the band 114. As the band's terminal circumferential end 184 is being inserted into the entrance 182 and the band 114 is subsequently moved in-and-out of the worm drive mechanism, the protrusion(s) 180 and the band 114 make surface-to-surface contact and the protrusion(s) lift and raise the band radially-outboard toward a shank of a screw 130. Threads of the shank can therefore more readily engage slots 124 of the band 114, and the threads are inserted into the slots for a greater insertion depth of thread-in-slot insertion. The greater insertion depth, as described above, can result in an increased radially contracting force applied by the band 114. The protrusion(s) 180 may also increase the number of threads concurrently inserted in slots, as previously described. Furthermore, as the screw 30 is urged toward the band 114 during rotation of the screw 130, if this indeed occurs, the protrusion(s) 180 and the attendant raising of the band can augment the improved thread-and-slot engagement described above for the pipe clamp 10 of FIGS. 1-7.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Furthermore, recitations of “at least one” component, element, or the like should not be used to create an inference that the alternative use of the articles “a” or “an” should be limited to the singular. Other terms are to be construed using their broadest reasonable meaning unless they are used in a context that requires a different interpretation.

1. A pipe clamp for a pipe lap joint involving at least one metal pipe, the pipe clamp comprising:
a band extending from a first circumferential end to a second circumferential end and having a plurality of slots spaced apart from one another along at least a section of said band; and
a worm drive mechanism connected to said band and operable to radially contract said band during tightening of the pipe clamp, said worm drive mechanism including a screw and a housing, said screw having a shank with threads that engage said slots of said band upon rotation of said screw during tightening of the pipe clamp, said shank having a terminal end portion, said housing having a cover that encloses at least a part of said shank and that includes an end wall adjacent said terminal end portion of said shank;
wherein, said band is received within said housing underneath said screw with at least one of said threads engaging at least one of said slots, and wherein, during tightening of the pipe clamp, said terminal end portion of said shank bears against said end wall of said cover and thrust loads exerted by said screw are braced at least in part by said cover and said end wall.

2. The pipe clamp of claim 1, wherein said band has at least one protrusion adjacent an entrance of said worm drive mechanism, said protrusion jutting radially-outboard, wherein, during introduction of said band into said entrance and during subsequent movement of said band through said worm drive mechanism, said protrusion raises said band toward said shank of said screw and said threads more readily engage said slots.

3. The pipe clamp of claim 1, wherein said cover includes a second end wall adjacent a head of said screw, and wherein, during tightening of the pipe clamp, said head of said screw bears against said second end wall of said cover and thrust loads exerted by said screw are braced at least in part by said cover and said second end wall.

4. The pipe clamp of claim 3, wherein the thrust loads exerted by said screw during tightening of the pipe clamp are braced in apportionment by said end wall of said cover and by said second end wall of said cover.

5. The pipe clamp of claim 1, wherein said end wall of said cover at least partially encloses said terminal end portion of said shank, and an inside surface of said end wall directly confronts said terminal end portion.

6. The pipe clamp of claim 1, wherein, during tightening of the pipe clamp, surface-to-surface abutment between said terminal end portion and said end wall urge said screw toward said band and enhances thread-and-slot engagement between said threads of said screw and said slots of said band.

7. The pipe clamp of claim 1, wherein a tapered outside surface of said shank adjacent said terminal end portion makes an angle beta (β) with respect to a longitudinal axis of said screw, and said end wall makes an angle alpha (α) with respect to a lengthwise extent of said cover, said angle beta (β) and said angle alpha (α) having values that are within five degrees (5°) of each other.

8. The pipe clamp of claim 7, wherein, during tightening of the pipe clamp, surface-to-surface abutment between said tapered outside surface of said shank and said end wall urges said screw toward said band and enhances thread-and-slot engagement between said threads of said screw and said slots of said band.

9. A pipe lap joint with a pair of overlapping metal pipes comprising the pipe clamp of claim 1.

10. A pipe clamp for a pipe lap joint involving at least one metal pipe, the pipe clamp comprising:
a band;
a worm drive mechanism including a screw and a housing, said screw having a head and a terminal end portion, said housing having a first end wall and a second end wall;
wherein, during tightening of the pipe clamp, said head of said screw bears against said first end wall of said housing, said terminal end portion of said screw bears against said second end wall of said housing, and thrust loads exerted during tightening of the pipe clamp are braced at least in part by said first end wall and are braced at least in part by said second end wall.

11. The pipe clamp of claim 10, wherein said band extends from a first circumferential end to a second circumferential end and has a plurality of slots situated along at least a section of said band.

12. The pipe clamp of claim 10, wherein said housing includes a cover and a saddle, said cover enclosing said terminal end portion of said screw and including said first and second end walls, said saddle connected to said cover via an opening-and-tab interconnection, said saddle connected to said band.

13. The pipe clamp of claim 10, wherein said terminal end portion of said screw makes an angle beta (β) relative to a longitudinal axis of said screw, and said second end wall makes an angle alpha (α) relative to a lengthwise extent of said housing of said worm drive mechanism, said angle beta (β) and said angle alpha (α) being substantially equal to each other.

14. The pipe clamp of claim 13, wherein, during tightening of the pipe clamp, surface-to-surface abutment between said terminal end portion of said screw and said second end wall of said housing urge said screw toward said band.

15. The pipe clamp of claim 10, wherein said band has at least one protrusion situated adjacent said worm drive mechanism when said band and said worm drive mechanism are assembled together, said protrusion raising said band radially-outwardly toward said screw.

16. A pipe clamp for a pipe lap joint involving at least one metal pipe, the pipe clamp comprising:
a band extending from a first circumferential end to a second circumferential end and having a set of slots situated along a section of said band; and
a worm drive mechanism actuated to cause radial contraction and expansion of said band, said worm drive mechanism including a screw and a housing, said screw having a head and a terminal end portion, said housing including a cover and a saddle, said cover having a first end wall and a second end wall, said saddle connected to said band;
wherein, during tightening of the pipe clamp, said head of said screw bears against said first end wall of said cover, said terminal end portion of said screw bears against said second end wall of said cover, and wherein, during tightening of the pipe clamp, surface-to-surface abutment between said terminal end portion of said screw and said second end wall of said cover urges said terminal end portion toward said band underlying said screw.

17. The pipe clamp of claim 16, wherein said second end wall spans from a top wall of said cover and extends radially inwardly to at least partially enclose said terminal end portion of said screw.
